(19) United States
(12) Patent Application Publication
(10) Pub. No.: US 2006/0286273 A1
(43) Pub. Date: Dec. 21, 2006

(54) Method of forming a reconstituted meat product

(76) Inventor: Gary Rohwer, Omaha, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/437,014

(22) Filed: May 18, 2006

Related U.S. Application Data
(60) Provisional application No. 60/682,254, filed on May 18, 2005.

(51) Int. Cl. A23L 1/31

(52) U.S. Cl. 426/641

(57) ABSTRACT

A method of reconstituting trims of meat into a finished meat product includes the steps of randomly placing the meat trims into a freezing container and cooling and freezing the assembled meat trims to form a block of frozen assembled meat trims, the block of frozen assembled meat trims being cooled and frozen to a temperature between −20° F. and 0° F. and is then tempered to a still-frozen yet higher temperature between 20° F. and 28° F. prior to pressing. It is then removed from the container and placed in a press die having a shape and dimensions approximately equal to the dimensions of the freezing container and the block is then pressed within the press die by a press device or the like thereby forming a generally log-like configuration which is removed from the press die and sliced via a slicing device.

### CROSS-REFERENCE TO RELATED PROVISIONAL PATENT

This application claims priority based on a provisional patent, specifically on the Provisional Patent Application Ser. No. 60/682,254 filed May 18, 2005.

### BACKGROUND OF THE INVENTION

1. Technical Field

The present invention relates to methods of reconstituting meat into meat product and, more particularly, to a meat reconstituting and forming process which utilizes trims of fish, poultry, pork or beef and involves the steps of placing the trims into an open-top pan having dimensions which generally coincide with the press die dimensions, freezing the assembled trims, tempering the frozen material to a still-frozen yet higher temperature prior to pressing, removing the material from the pan and placing it in a press die which is then activated to press the material into a log-like configuration and then removing the log of material from the press die and slicing it according to the intentions of the manufacturer of the reconstituted meat log.

2. Description of the Prior Art

One of the ongoing concerns encountered in the production of meat products is the large amount of waste material which is left over after the cutting of the meat products into various cuts has taken place. Specifically, much of the fat and muscle tissue which is cut away from the meat product during the production thereof is processed further to attempt to use the waste material, but it is not always an easy matter to reconstitute these waste materials into saleable products. It is important to note that the waste materials, such as the trimmed muscle taken from the meat product being produced, are not in and of themselves unusable, but rather it is their small size and shape which render them unusable for many of the products which are purchased by consumers. There is therefore a need for a process which will reconstitute these waste materials into a product which is saleable to consumers and will have many of the properties which consumers find desirable in meat products.

Several examples of attempts to reconstitute waste meat products are found in the prior art, including such methods as shown in Liberman, et al., U.S. Pat. No. 6,248,381, and Groneberg-Nienstedt et al., published Patent Application Serial No. U.S. 2003/0113422. Each of these patents and patent applications disclose methods of reconstituting meat from various waste materials, and specifically the Liberman patent discloses a method which involves freezing the trims, configuring the frozen trims, and compressing the frozen trims with an external force to form purge on the outer surface thereof. One of the disadvantages of Liberman, however, is that the purge material which is formed by the freezing and rupturing of cells within the meat will make the resulting meat product less appetizing due to the presence of the purge material which will be found throughout the resulting reconstituted meat product. Also, the rupturing of the cells in the meat product to produce the purge can result in decreased tenderness and flavor, which detracts from the appeal of the resulting meat product. There is therefore a need for a process or method which will utilize the meat trims, yet will not cause partial destruction of the meat trims during the freezing and reconstituting process, excepting that which is necessary to combine the meat trims to form the reconstituted meat product.

Therefore, an object of the present invention is to provide a method of forming a reconstituted meat product which will reuse the waste meat cut from meat producing animals to provide a tasty and aesthetically pleasing reconstituted meat product.

Another object of the present invention is to provide a method of forming a reconstituted meat product which includes the steps of placing the trims into an open-top pan having dimensions which generally coincide with the press die dimensions, freezing the assembled trims, tempering the frozen material to a still-frozen yet higher temperature prior to pressing, removing the material from the pan and placing it in a press die which is then activated to press the material into a log-like configuration and then removing the log of material from the press die and slicing it according to the intentions of the manufacturer of the reconstituted meat log.

Another object of the present invention is to provide a method of forming a reconstituted meat product which will result in a meat product which will generally not break or fall apart prior to consumption and which will generally have the consistency of the unmodified meat product from which it is constituted.

Another object of the present invention is to provide a method of forming a reconstituted meat product in which the trims are randomly arranged within the pan during insertion in order to generally eliminate fracture or fault lines forming in the frozen block of meat product due to the intertwined configuration of the trims therein, thereby lowering the incidences of crumbling of the formed product.

Another object of the present invention is to provide a method of forming a reconstituted meat product which can be used with many different types of meat products, including beef, pork, chicken and seafood.

Finally, an object of the present invention is to provide a method of forming a reconstituted meat product which is relatively simple in operation and which produces a reconstituted meat product which is safe, palatable and aesthetically pleasing.

### SUMMARY OF THE INVENTION

The present invention provides a method of reconstituting trims of meat into a finished meat product including the steps of randomly placing the meat trims into a freezing container having a specific shape and having specific height, width and depth dimensions and cooling and freezing the assembled meat trims within the freezing container to form a block of frozen assembled meat trims, the block of frozen assembled meat trims being cooled and frozen to a temperature between negative twenty degrees and zero degrees Fahrenheit (−20° F. and 0° F.). The block of frozen assembled meat trims within the freezing container is then tempered to a still-frozen yet higher temperature between twenty degrees and twenty-eight degrees Fahrenheit (20° F. and 28° F.) prior to pressing and then the block of frozen assembled meat trims is removed from the freezing container. The block of frozen assembled meat trims is then placed in a press die having a shape and dimensions approximately equal to the specific shape and specific height, width and depth dimensions of the freezing container and the block of frozen assembled meat trims is then pressed within the press die by a press device or the like thereby forming a generally log-like configuration of the frozen assembled meat trims wherein the meat trims are compressed with one another. Finally, the log-like configuration of the frozen assembled meat trims is removed from the press die and sliced via a slicing device whereby desired cuts of the frozen assembled meat trims are obtained.

The method of reconstituting trims of meat as thus described provides many significant advantages over other methods of forming reconstituted meat products. For example, because the trims are randomly placed in the freezing container, the resulting block of frozen assembled meat trims will generally be more cohesive than other blocks of meat, due to the crisscrossing and interlocking arrangement of the randomly place meat trims. Also, because the block is deeply frozen, then tempered to bring it up in temperature, there is far less production of ice crystals within the block which can degrade the quality and flavor of the resulting meat product and also decreases the amount of purge produced during the pressing process, which makes for an improved product. Finally, because the freezing container is of the same size and shape as the press die, the pressing process by which the block of frozen assembled meat trims is formed into the log-like configuration is performed without producing significant waste material, thus increasing the efficiency of the process. It is thus seen that the present invention provides a substantial improvement over those methods found in the prior art.

### BRIEF DESCRIPTION OF THE DRAWINGS

FIG. 1 is a flow diagram showing the steps of the process of manufacture of the present invention.

### DESCRIPTION OF THE PREFERRED EMBODIMENT

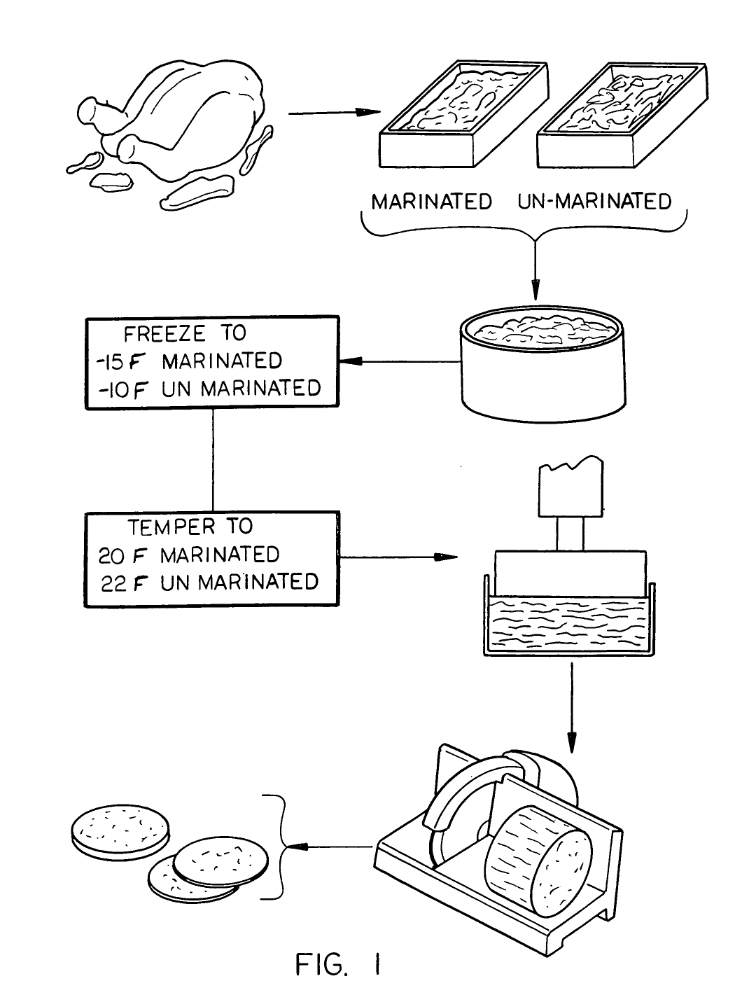

The method of forming a reconstituted meat product is best shown in FIG. 1 as including the following steps. The waste material is trim muscle from any protein origin, including such sources as fish, poultry, pork or beef, and generally the trimmed muscle would be somewhat smaller pieces of meat generally having dimensions of approximately one-half inch to four inches in length and widths of approximately one-half inch to two inches, depending on the nature of the meat product from which the trim is taken and the processing step from which the trim is removed. The resulting trim material may then be either marinated or unmarinated as it is prepared for the next step in the process, and, of course, marination of the meat trim material would be understood by one skilled in the art of production of meat products. The material would then be placed into an open-top pan which is preferably of the same general size and shape as the press die into which the meat material is to be placed, and therefore it is often found that the trim material will be placed within a generally cylindrical container, as shown in FIG. 1.

Once the trim material has been placed within the cylindrical container, the entire container is placed in a freezer unit and frozen at a temperature of approximately zero degrees to negative twenty degrees Fahrenheit (0° F. to −20° F.), depending on the nature of the trim material and whether the trim material has been marinated or has not been marinated. Once the entire block of trim material has been frozen, it is then tempered to bring the temperature upwards to a temperature of approximately twenty to twenty-eight degrees Fahrenheit (20° F. to 28° F.), again depending on the constitution of the trim material and whether it has been marinated or has not been marinated, thus preparing the frozen block of trim material for placement within the press die for pressing thereof.

While virtually any method and device for pressing the trimmed meat material is acceptable for use with the present invention, there are several press devices used in related industries which would be ideally suited for use with the present invention. The important features which the press device must include are that the press die must be of a standard shape which is replicated by the cylindrical container and also the press die must be capable of pressing the trim material at pressures of upwards of one thousand psi, actually approximately 1150 psi. To commence pressing of the trim material, the frozen block of trim material is removed from the cylindrical container and placed within the press die which is then activated to press the frozen trim material at a pressure of approximately one thousand one hundred psi to twelve hundred psi (1100 to 1200), again depending on the specific trim material used and whether the trim material has been marinated or is not marinated. The pressing device will continue the press for approximately fifteen to thirty seconds, at which time it will cycle to release the pressed log of trim material which can then be removed and taken for further processing.

Once the pressing step has been completed, the pressed log of trim material may then be sliced into patties or other individual units of the pressed trim material, or, alternatively, the entire log of pressed trim material may be sold as is for processing on location at the retail or wholesale outlet receiving the log of pressed trim material.

It is important to note that some of the key improvements of the present method over those examples found in the prior art include the fact that the trim material is placed in the container prior to freezing, thus allowing the trim material to fit together in a much more cohesive and tight arrangement which enables the finished log of material to hold together better than those logs of reconstituted meat found in the prior art. It has been found that the random alignment of the meat trim pieces within the cylindrical container prior to freezing actually can result in a more cohesive final reconstituted meat product being formed, in addition to saving the considerable time and effort which is required to align other reconstituted meat products found in the prior art. Also, because the frozen block of trim material is frozen in the shape of the die into which the block is to be placed, it is much easier for a user of the present method to practice the method, as he or she need only remove the frozen block of material from the cylindrical container and place it within the press die which it has been pre-shaped to fit. Once the pressing process is completed, the resulting log of pressed trim material is ready for further processing as is, and does not require further steps to complete the preparation process. The method of the present invention thus provides a substantial improvement over those methods found in the prior art.

It is to be understood that numerous additions, substitutions, and modifications may be made to the method of preparing a reconstituted meat product of the present invention which fall within the intended broad scope of the above description. For example, the size and shape of the cylindrical container may be modified such that the container may not be cylindrical but may be designed to replicate various types of cuts of meat, such as breasts, fillets, chicken tenders and nuggets, and other such cuts of meat which have a specific shape which the consumer associates therewith. This would merely require modification of the container into which the trimmed pieces are inserted and modification of the shape of the press die to replicate the shape of the container in order to provide a simple and efficient transfer of the frozen block of trim material to the press die. Also, it should be noted that the specific temperature at which the block of trim material is to be frozen and then tempered may be modified or changed depending on the most efficient temperature ranges to be used with the various types of trim material, and such temperatures will likely be found through further experimentation with the process of the present invention. However, it is important to note that the step of combining the unfrozen trim material into the container prior to freezing, then freezing the material and placing the frozen block of material in the press die is critical to the functioning of the present invention as it has been found that this process does not produce purge due to the freezing of the material which can degrade the quality of the meat product being produced. Also, it should be noted that it is preferred that the slicing operation used with the product of the present invention should produce thicker slices of approximately ⅓″ to 1″ in thickness to better replicate the shape and thickness of the breasts, fillets, chicken tenders and nuggets which the present invention is intended to replicate. Finally, various types of further processing may be done to the log of reconstituted meat material produced from the process of the present invention, any of which would be understood by those skilled in the art of meat preparation.

There has therefore been shown and described a method of forming a reconstituted meat product which accomplishes at least all of its intended objectives.

I claim:

1. A method of reconstituting trims of meat into a finished meat product comprising the steps:
randomly placing the meat trims into a freezing container having a specific shape and having specific height, width and depth dimensions;
cooling and freezing the assembled meat trims within said freezing container to form a block of frozen assembled meat trims, said block of frozen assembled meat trims being cooled and frozen to a temperature between negative twenty degrees and zero degrees Fahrenheit (−20° F. and 0° F.);
tempering said block of frozen assembled meat trims within said freezing container to a still-frozen yet higher temperature between twenty degrees and twenty-eight degrees Fahrenheit (20° F. and 28° F.) prior to pressing;
removing said block of frozen assembled meat trims from said freezing container;
placing said block of frozen assembled meat trims in a press die having a shape and dimensions approximately equal to said specific shape and specific height, width and depth dimensions of said freezing container;
pressing said block of frozen assembled meat trims in said press die thereby forming a generally log-like configuration of said frozen assembled meat trims wherein said meat trims are compressed with one another;
removing said log-like configuration of said frozen assembled meat trims from said press die; and
slicing said log-like configuration of said frozen assembled meat trims whereby desired cuts of said frozen assembled meat trims are obtained.

2. The method of forming a reconstituted meat product of claim 1 wherein said step of pressing said block of frozen assembled meat trims in said press die comprises pressing the trim material at pressures between one thousand to one thousand five hundred (1,000 to 1,500) psi.

3. The method of forming a reconstituted meat product of claim 1 wherein said freezing container comprises an open-top box which is one of generally rectangular and cylindrical in shape.

4. The method of forming a reconstituted meat product of claim 1 wherein said freezing container comprises an open-top box having a cross-sectional shape corresponding to various types of cuts of meat selected from the group consisting of breasts, fillets, chicken tenders and nuggets.

5. A method of reconstituting trims of meat into a finished meat product comprising the steps:
randomly placing the meat trims into a generally cylindrical freezing container having specific height, width and depth dimensions;
cooling and freezing the assembled meat trims within said generally cylindrical freezing container to form a block of frozen assembled meat trims, said block of frozen assembled meat trims being cooled and frozen to a temperature between negative twenty degrees and zero degrees Fahrenheit (−20° F. and 0° F.);
tempering said block of frozen assembled meat trims within said generally cylindrical freezing container to a still-frozen yet higher temperature between twenty degrees and twenty-eight degrees Fahrenheit (20° F. and 28° F.) prior to pressing;
removing said block of frozen assembled meat trims from said generally cylindrical freezing container;
placing said block of frozen assembled meat trims in a generally cylindrical press die having dimensions approximately equal to said specific height, width and depth dimensions of said freezing container;
pressing said block of frozen assembled meat trims in said generally cylindrical press die thereby forming a generally log-like configuration of said frozen assembled meat trims wherein said meat trims are compressed with one another;
removing said log-like configuration of said frozen assembled meat trims from said press die; and
slicing said log-like configuration of said frozen assembled meat trims whereby desired cuts of said frozen assembled meat trims are obtained.

6. The method of forming a reconstituted meat product of claim 5 wherein said step of pressing said block of frozen assembled meat trims in said press die comprises pressing the trim material at pressures between one thousand to one thousand five hundred (1,000 to 1,500) psi.

7. A method of reconstituting trims of meat into a finished meat product comprising the steps:
randomly placing the meat trims into a freezing container having a specific cross-sectional shape corresponding to various types of cuts of meat selected from the group consisting of breasts, fillets, chicken tenders and nuggets and having specific height, width and depth dimensions;
cooling and freezing the assembled meat trims within said freezing container to form a block of frozen assembled meat trims, said block of frozen assembled meat trims being cooled and frozen to a temperature between negative twenty degrees and zero degrees Fahrenheit (−20° F. and 0° F.);
tempering said block of frozen assembled meat trims within said freezing container to a still-frozen yet higher temperature between twenty degrees and twenty-eight degrees Fahrenheit (20° F. and 28° F.) prior to pressing;
removing said block of frozen assembled meat trims from said freezing container;
placing said block of frozen assembled meat trims in a press die having a shape and dimensions approximately equal to said specific shape and specific height, width and depth dimensions of said freezing container;
pressing said block of frozen assembled meat trims in said press die thereby forming a generally log-like configuration of said frozen assembled meat trims wherein said meat trims are compressed with one another;
removing said log-like configuration of said frozen assembled meat trims from said press die; and
slicing said log-like configuration of said frozen assembled meat trims whereby desired cuts of said frozen assembled meat trims are obtained.

8. The method of forming a reconstituted meat product of claim 7 wherein said step of pressing said block of frozen assembled meat trims in said press die comprises pressing the trim material at pressures between one thousand to one thousand five hundred (1,000 to 1,500) psi.
